(19) United States
(12) Patent Application Publication
(10) Pub. No.: US 2026/0170102 A1
(43) Pub. Date: Jun. 18, 2026

(54) SYSTEM AND METHOD FOR ADAPTIVE AND ROBUST WATERMARK FOR GENERATIVE TABULAR DATA

(71) Applicant: JPMorgan Chase Bank, N.A., New York, NY (US)

(72) Inventors: Daniel NGO, Pittsburgh, PA (US); Daniel SCOTT, New York, NY (US); Saheed OBITAYO, New York, NY (US); Vamsi Krishna POTLURU, New York, NY (US); Manuela VELOSO, New York, NY (US)

(73) Assignee: JPMorgan Chase Bank, N.A., New York, NY (US)

(21) Appl. No.: 18/984,141

(22) Filed: Dec. 17, 2024

(51) Int. Cl. G06F 21/16; H04L 9/08; H04L 9/32

(52) U.S. Cl. CPC G06F 21/16; H04L 9/0869; H04L 9/3236

(57) ABSTRACT

Various methods and processes, apparatuses/systems, and media for watermarking generative tabular data in a flexible and robust manner are disclosed. A processor partitions a feature space into a pair of columns (key, value) by calling a subroutine; divides a range of features in each key column into bins of a predefined size (1/b) to form b consecutive intervals; computes a hash by utilizing a center of the bins for each key column which becomes a seed for a random number generator; randomly generates, by utilizing the random number generator, predefined first and second color-coded intervals for corresponding value column, wherein each color-coded interval is of size 1/b; and embeds a watermark in the continuous features of the value column by applying an algorithm such that a feature of the value column in the first color-coded interval moves to nearest second color-coded interval.

### TECHNICAL FIELD

This disclosure generally relates to data processing, and, more particularly, to methods and apparatuses for implementing a domain, platform, language, cloud, and database agnostic tabular data watermarking module configured for watermarking generative tabular data, data that may be displayed in columns or tables, in a flexible and robust manner.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Synthetic data may refer to information that may be artificially generated rather than produced by real-world events. Typically created using algorithms, synthetic data may be deployed to validate mathematical models and to train machine learning models. Thus, data generated by a computer simulation rather than human-generated may be seen as synthetic data. A generative model may typically refer to a type of machine learning model that aims to learn the underlying patterns or distributions of data in order to generate new, similar data, i.e., synthetic data.

With the recent development in generative models, synthetic data has become more ubiquitous with applications ranging from health care to finance. Among these applications, synthetic data may serve as an alternative option to human-generated data due to its high quality and relatively low cost to procure. However, there appears to be a growing concern that carelessly adopting synthetic data with the same frequency as human-generated data may lead to misinformation and privacy breaches, that may ultimately lead to attacks on security systems of a network. Thus, it is important for synthetic data to be detectable by any upstream data-owner.

Watermarking has recently emerged as a promising solution to synthetic data detection with applications in generative text, and relational data. A watermark is typically a hidden pattern embedded in the data that may be indiscernible to an oblivious human decision maker, yet can be algorithmically detected through an efficient procedure. The watermark carries several desirable properties, notably: (i) fidelity—it should not degrade the quality and usability of the original dataset; (ii) detectability—it should be reliably identified through a specific detection process; (iii) robustness—it should withstand manipulations from an adversary.

Applying watermark to synthetic tabular dataset, however, may prove to be particularly challenging due to its rigid structure. A tabular dataset typically follows a specific format where each row contains a fixed number of features, which are precise information about a certain individual. Hence, even perturbation of a subset of features in the data may have substantial effect in the performance of downstream tasks. Furthermore, tabular data may commonly be subjected to various methods of data manipulation by the downstream data scientist, e.g., feature selection and data alteration, to improve data quality and enable efficient learning.

While many conventional tools have proposed watermarking techniques for tabular data, they often fail to address how their watermark perform under these seemingly innocuous attack masked as preprocessing tasks, thereby substantially impacting on data quality and downstream utility, failing to detect watermarked datasets efficiently, subjecting the underlying networks to multiple attacks commonly observed in data science resulting in ultimate network failures.

### SUMMARY

The present disclosure, through one or more of its various aspects, embodiments, and/or specific features or sub-components, provides, among other features, various systems, servers, devices, methods, media, programs, and platforms for implementing a domain, platform, language, cloud, and database agnostic tabular data watermarking module configured for watermarking generative tabular data in a flexible and robust manner, but the disclosure is not limited thereto. For example, the tabular data watermarking module as disclosed herein may implement a flexible watermarking algorithm for tabular data that leverages an overall structure of a feature space to form pairs of (key, value) columns for a more fine-grained watermark embedding, thereby substantially improving data quality and downstream utility, efficiently detecting watermarked datasets, protecting underlying networks from malicious or non-malicious attacks commonly observed in data science, etc., but the disclosure is not limited thereto.

In some embodiments, a method for watermarking tabular data by utilizing one or more processors along with allocated memory is disclosed. The method may include: receiving an original tabular dataset output from a generative model, the original tabular dataset having a feature space that includes a plurality of continuous features corresponding to an application; and partitioning, with a knowledge of a downstream task corresponding to the application, the feature space into a pair of columns by calling a subroutine via an application programming interface, wherein a first column of the pair of columns is labeled as a key column and a second column of the pair of columns is labeled as a value column; dividing a range of features in each key column into bins of a predefined size (1/b) to form b consecutive intervals; computing a hash by utilizing a center of the bins for each key column which becomes a seed for a random number generator; randomly generating, by utilizing the random number generator, predefined first and second color-coded intervals for corresponding value column, wherein each color-coded interval is of size 1/b; and embedding the watermark in the continuous features of the value column by applying an algorithm such that a feature of the value column in the first color-coded interval moves to nearest second color-coded interval.

In some embodiments, in partitioning the feature space into the pair of columns, the method may further include: pairing the plurality of continuous features uniformly at random.

In some embodiments, in partitioning the feature space into the pair of columns, the method may further include: pairing the plurality of continuous features according to a feature importance ordering, where features with similar importance are paired.

In some embodiments, the method may further include: repeating the processes of partitioning, dividing, computing, randomly generating, and embedding as disclosed above until all value columns are watermarked.

In some embodiments, the method may further include: outputting a watermarked dataset of the original tabular dataset to be utilized for the downstream task corresponding to the application.

In some embodiments, in embedding the watermark in the continuous features of the value column by applying the algorithm, the method may further include: computing a distance between empirical distributions of the original tabular dataset and the watermarked dataset based on an analysis on Wasserstein distance.

In some embodiments, the method may further include: embedding the watermark in the continuous features of the value column by using a bin size of 10⁻² thereby only considering columns that contain floating point numbers with at least two decimal places, but the disclosure is not limited to this bin size. Any configurable bin size may be utilized in consistent with the processes disclosed herein.

In some embodiments, a system for watermarking generative tabular dataset is disclosed. The system may include: a processor; and a memory operatively connected to the processor via a communication interface, the memory storing computer readable instructions, when executed, may cause the processor to: receive an original tabular dataset output from a generative model, the original tabular dataset having a feature space that includes a plurality of continuous features corresponding to an application; and partition, with a knowledge of a downstream task corresponding to the application, the feature space into a pair of columns by calling a subroutine via an application programming interface, wherein a first column of the pair of columns is labeled as a key column and a second column of the pair of columns is labeled as a value column; divide a range of features in each key column into bins of a predefined size (1/b) to form b consecutive intervals; compute a hash by utilizing a center of the bins for each key column which becomes a seed for a random number generator; randomly generate, by utilizing the random number generator, predefined first and second color-coded intervals for corresponding value column, wherein each color-coded interval is of size 1/b; and embed the watermark in the continuous features of the value column by applying an algorithm such that a feature of the value column in the first color-coded interval moves to nearest second color-coded interval.

In some embodiments, in partitioning the feature space into the pair of columns, the processor may be further configured to: pair the plurality of continuous features uniformly at random.

In some embodiments, in partitioning the feature space into the pair of columns, the processor may be further configured to: pair the plurality of continuous features according to a feature importance ordering, where features with similar importance are paired.

In some embodiments, the processor may be further configured to: repeat the processes of partition, divide, compute, randomly generate, and embed as disclosed above until all value columns are watermarked.

In some embodiments, the processor may be further configured to: output a watermarked dataset of the original tabular dataset to be utilized for the downstream task corresponding to the application.

In some embodiments, in embedding the watermark in the continuous features of the value column by applying the algorithm, the processor may be further configured to: compute a distance between empirical distributions of the original tabular dataset and the watermarked dataset based on an analysis on Wasserstein distance.

In some embodiments, the processor may be further configured to: embed the watermark in the continuous features of the value column by using a bin size of 10⁻² thereby only considering columns that contain floating point numbers with at least two decimal places, but the disclosure is not limited to this bin size. Any configurable bin size may be utilized in consistent with the processes disclosed herein.

In some embodiments, a non-transitory computer readable medium configured to store instructions for watermarking generative tabular dataset is disclosed. The instructions, when executed, may cause a processor to perform the following: receiving an original tabular dataset output from a generative model, the original tabular dataset having a feature space that includes a plurality of continuous features corresponding to an application; and partitioning, with a knowledge of a downstream task corresponding to the application, the feature space into a pair of columns by calling a subroutine via an application programming interface, wherein a first column of the pair of columns is labeled as a key column and a second column of the pair of columns is labeled as a value column; dividing a range of features in each key column into bins of a predefined size (1/b) to form b consecutive intervals; computing a hash by utilizing a center of the bins for each key column which becomes a seed for a random number generator; randomly generating, by utilizing the random number generator, predefined first and second color-coded intervals for corresponding value column, wherein each color-coded interval is of size 1/b; and embedding the watermark in the continuous features of the value column by applying an algorithm such that a feature of the value column in the first color-coded interval moves to nearest second color-coded interval.

In some embodiments, in partitioning the feature space into the pair of columns, the instructions, when executed, may cause the processor to perform the following: pairing the plurality of continuous features uniformly at random.

In some embodiments, in partitioning the feature space into the pair of columns, the instructions, when executed, may cause the processor to perform the following: pairing the plurality of continuous features according to a feature importance ordering, where features with similar importance are paired.

In some embodiments, the instructions, when executed, may cause the processor to perform the following: repeating the processes of partitioning, dividing, computing, randomly generating, and embedding as disclosed above until all value columns are watermarked.

In some embodiments, the instructions, when executed, may cause the processor to perform the following: outputting a watermarked dataset of the original tabular dataset to be utilized for the downstream task corresponding to the application.

In some embodiments, in embedding the watermark in the continuous features of the value column by applying the algorithm, the instructions, when executed, may cause the processor to perform the following: computing a distance between empirical distributions of the original tabular dataset and the watermarked dataset based on an analysis on Wasserstein distance.

In some embodiments, the instructions, when executed, may cause the processor to perform the following: embedding the watermark in the continuous features of the value column by using a bin size of 10⁻² thereby only considering columns that contain floating point numbers with at least two decimal places, but the disclosure is not limited to this bin size. Any configurable bin size may be utilized in consistent with the processes disclosed herein.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic tabular data watermarking module configured for watermarking generative tabular data in a flexible and robust manner in accordance with an embodiment.

FIG. 2 illustrates a diagram of a network environment with a platform, language, database, and cloud agnostic tabular data watermarking device in accordance with an embodiment.

FIG. 3 illustrates a system diagram for implementing a platform, language, database, and cloud agnostic tabular data watermarking device having a platform, language, database, and cloud agnostic tabular data watermarking module in accordance with an embodiment.

FIG. 4 illustrates a system diagram for implementing a platform, language, database, and cloud agnostic tabular data watermarking module of FIG. 3 in accordance with an embodiment.

FIG. 5 illustrates an algorithm for watermarking generative tabular data in a flexible and robust manner as implemented by the platform, language, database, and cloud agnostic tabular data watermarking module of FIG. 4 in accordance with an embodiment.

FIG. 6 illustrates a flow chart of a process implemented by the platform, language, database, and cloud agnostic tabular data watermarking module of FIG. 4 for watermarking generative tabular data in a flexible and robust manner in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, watermarking has recently emerged as a promising solution to synthetic data detection with applications in generative text, and relational data. Applying watermark to synthetic tabular dataset, however, may prove to be particularly challenging due to its rigid structure. A tabular dataset typically follows a specific format where each row contains a fixed number of features, which are precise information about a certain individual. Hence, even perturbation of a subset of features in the data may have substantial effect in the performance of downstream tasks. Furthermore, tabular data may commonly be subjected to various methods of data manipulation by the downstream data scientist, e.g., feature selection and data alteration, to improve data quality and enable efficient learning.

For example, one conventional approach in watermarking tabular data may involve embedding the watermark in a least significant bit of some cells, i.e., setting them to be either “0” or “1” based on a hash value computed using primary and private keys. Another conventional approach may involve embedding the watermark into the statistics of the data where the rows of the tabular data are partitioned into different subsets and the watermark is embedded by modifying the subset-related statistics. Yet another conventional approach may involve only embedding the watermark in a prediction target feature. While this approach may handle several attacks as well as categorical features, its result is mostly focused on watermarking one feature using a random seed, which is often insufficient in practice.

While many conventional approaches/tools mentioned above have proposed watermarking techniques for tabular data, they often fail to address how their watermark perform under these seemingly innocuous attack masked as preprocessing tasks, thereby substantially impacting on data quality and downstream utility, failing to detect watermarked datasets efficiently, subjecting the underlying networks to multiple malicious or non-malicious attacks commonly observed in data science resulting in ultimate network failures.

To address the above-noted technical problems associated with conventional watermarking systems, the present disclosure, through one or more of its various aspects, embodiments, and/or specific features or sub-components, provides, among other features, various systems, servers, devices, methods, media, programs, and platforms for implementing a domain, platform, language, cloud, and database agnostic tabular data watermarking module configured for implementing a flexible watermarking algorithm as disclosed herein for tabular data that leverages an overall structure of a feature space to form pairs of (key, value) columns for a more fine-grained watermark embedding, thereby substantially improving data quality and downstream utility, efficiently detecting watermarked datasets, protecting underlying networks from malicious or non-malicious attacks commonly observed in data science, etc., but the disclosure is not limited thereto.

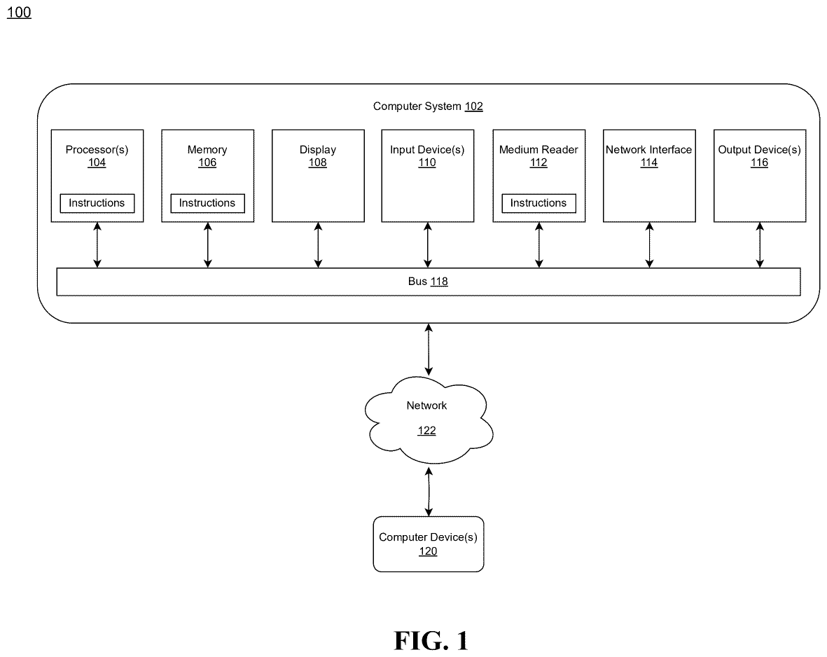

For example, the algorithm implemented by the domain, platform, language, cloud, and database agnostic tabular data watermarking module to improve the above-noted technical problems associated with conventional watermarking systems may include: receiving an original tabular dataset output from a generative model, the original tabular dataset having a feature space that includes a plurality of continuous features corresponding to an application; and partitioning, with a knowledge of a downstream task corresponding to the application, the feature space into a pair of columns by calling a subroutine via an application programming interface, wherein a first column of the pair of columns is labeled as a key column and a second column of the pair of columns is labeled as a value column; dividing a range of features in each key column into bins of a predefined size (1/b) to form b consecutive intervals; computing a hash by utilizing a center of the bins for each key column which becomes a seed for a random number generator; randomly generating, by utilizing the random number generator, predefined first and second color-coded intervals for corresponding value column, wherein each color-coded interval is of size 1/b; and embedding the watermark in the continuous features of the value column by applying an algorithm such that a feature of the value column in the first color-coded interval moves to nearest second color-coded interval, but the disclosure is not limited thereto. Details of this algorithm for watermarking generative tabular data in a flexible and robust manner are described below with reference to FIGS. 1-6.

FIG. 1 is an exemplary system 100 for use in implementing a platform, language, database, and cloud agnostic tabular data watermarking module configured for watermarking generative tabular data in a flexible and robust manner in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the tabular data watermarking module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the tabular data watermarking module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

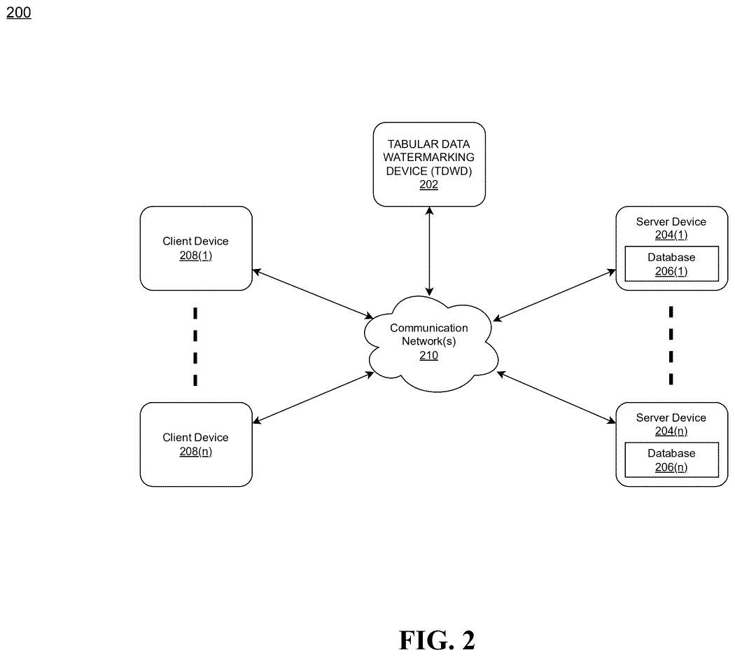

Referring to FIG. 2, a schematic of an exemplary network environment 200 for implementing a language, platform, database, and cloud agnostic tabular data watermarking device (TDWD) of the instant disclosure is illustrated.

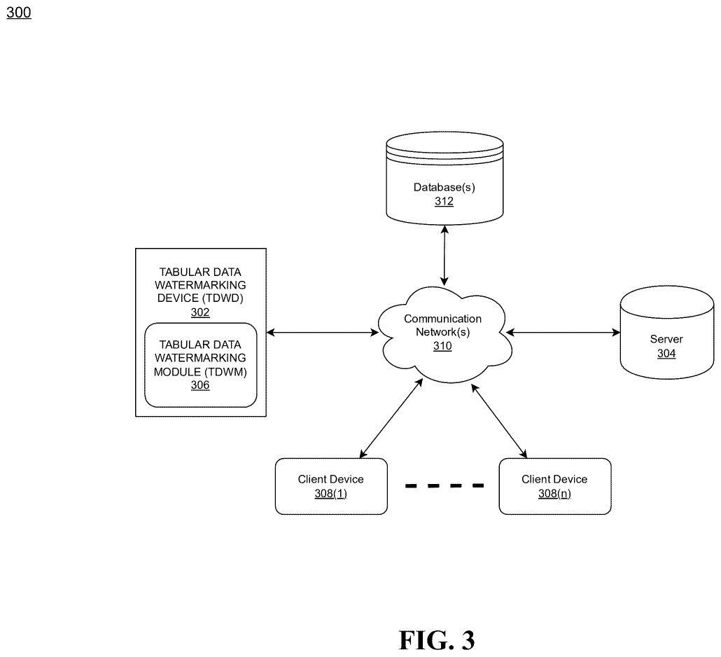

In some embodiments, the above-described problems associated with conventional tools may be overcome by implementing an TDWD 202 as illustrated in FIG. 2 that may be configured for implementing a platform, language, database, and cloud agnostic tabular data watermarking module configured for watermarking generative tabular data in a flexible and robust manner as disclosed herein with reference to FIGS. 3-6, but the disclosure is not limited thereto.

The TDWD 202 may have one or more computer system 102s, as described with respect to FIG. 1, which in aggregate provide the necessary functions.

The TDWD 202 may store one or more applications that may include executable instructions that, when executed by the TDWD 202, cause the TDWD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the TDWD 202 itself, may be located in virtual server(s) running in a cloud-based computing environment rather than being tied to one or more specific physical network computing devices. Also, the application(s) may be running in one or more virtual machines (VMs) executing on the TDWD 202. Additionally, in one or more embodiments of this technology, virtual machine(s) running on the TDWD 202 may be managed or supervised by a hypervisor.

In the network environment 200 of FIG. 2, the TDWD 202 may be coupled to a plurality of server devices 204(1)-204(n) that hosts a plurality of databases 206(1)-206(n), and also to a plurality of client devices 208(1)-208(n) via communication network(s) 210. A communication interface of the TDWD 202, such as the network interface 114 of the computer system 102 of FIG. 1, operatively couples and communicates between the TDWD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TDWD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The TDWD 202 may be a standalone device or integrated with one or more other devices or apparatuses, such as one or more of the server devices 204(1)-204(n). In some embodiments, the TDWD 202 may be hosted by one of the server devices 204(1)-204(n), and other arrangements may also be possible. Moreover, one or more of the devices of the TDWD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the TDWD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the TDWD 202 that may efficiently provide a platform for implementing a platform, language, database, and cloud agnostic tabular data watermarking module configured for watermarking generative tabular data in a flexible and robust manner, but the disclosure is not limited thereto.

The client devices 208(1)-208(n) may run interface applications, such as standard web browsers or standalone client applications, which may provide an interface to communicate with the TDWD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the TDWD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the TDWD 202, the server devices 204(1)-204(n), or the client devices 208(1)-208(n), in some embodiments, may be configured to operate as virtual instances on the same physical machine. In some embodiments, one or more of the TDWD 202, the server devices 204(1)-204(n), or the client devices 208(1)-208(n) may operate on the same physical device rather than as separate devices communicating through communication network(s) 210. Additionally, there may be more or fewer TDWDs 202, server devices 204(1)-204(n), or client devices 208(1)-208(n) than illustrated in FIG. 2. In some embodiments, the TDWD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

FIG. 3 illustrates a system diagram for implementing a platform, language, and cloud agnostic TDWD having a platform, language, database, and cloud agnostic tabular data watermarking module (TDWM) in accordance with an embodiment.

As illustrated in FIG. 3, the system 300 may include an TDWD 302 within which an TDWM 306 may be embedded, a server 304, a database(s) 312, a plurality of client devices 308(1) . . . 308(n), and a communication network 310.

In some embodiments, the TDWD 302 including the TDWM 306 may be connected to the server 304, and the database(s) 312 via the communication network 310. The TDWD 302 may also be connected to the plurality of client devices 308(1) . . . 308(n) via the communication network 310, but the disclosure is not limited thereto.

According to exemplary embodiment, the TDWD 302 is described and shown in FIG. 3 as including the TDWM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the TDWM 306 may be configured to receive real-time feed of data from the plurality of client devices 308(1) . . . 308(n) and secondary sources via the communication network 310.

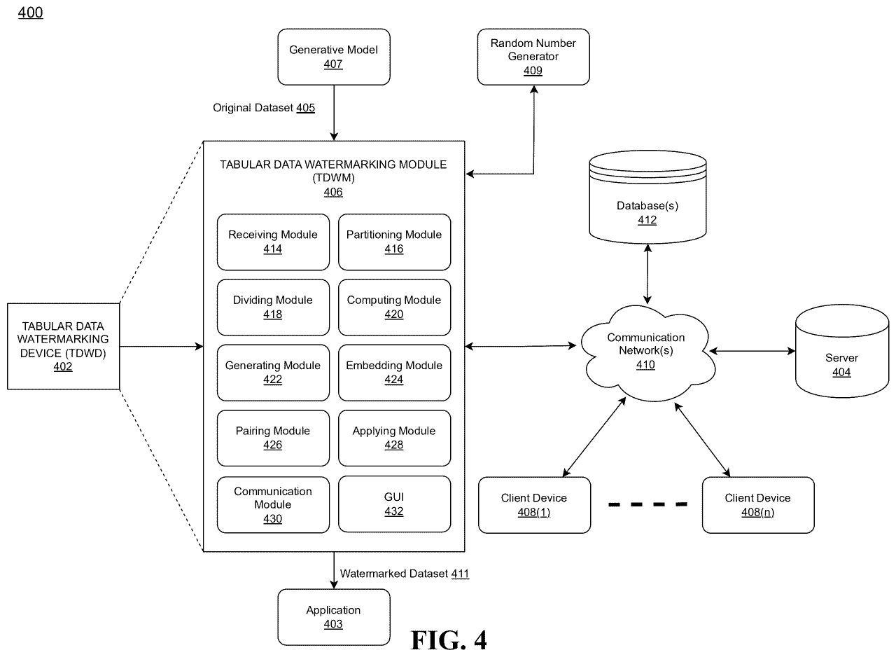

As may be described below, the TDWM 306 may be configured to: receive an original tabular dataset output from a generative model, the original tabular dataset having a feature space that includes a plurality of continuous features corresponding to an application; and partition, with a knowledge of a downstream task corresponding to the application, the feature space into a pair of columns by calling a subroutine via an application programming interface, wherein a first column of the pair of columns is labeled as a key column and a second column of the pair of columns is labeled as a value column; divide a range of features in each key column into bins of a predefined size (1/b) to form b consecutive intervals; compute a hash by utilizing a center of the bins for each key column which becomes a seed for a random number generator; randomly generate, by utilizing the random number generator, predefined first and second color-coded intervals for corresponding value column, wherein each color-coded interval is of size 1/b; and embed the watermark in the continuous features of the value column by applying an algorithm such that a feature of the value column in the first color-coded interval moves to nearest second color-coded interval, but the disclosure is not limited thereto. Details of the TDWM 306 are described below with reference to FIGS. 4-6.

The plurality of client devices 308(1) . . . 308(n) are illustrated as being in communication with the TDWD 302. In this regard, the plurality of client devices 308(1) . . . 308(n) may be “clients” (e.g., customers) of the TDWD 302 and are described herein as such. Nevertheless, it is to be known and understood that the plurality of client devices 308(1) . . . 308(n) need not necessarily be “clients” of the TDWD 302, or any entity described in association therewith herein. Any additional or alternative relationship may exist between either or both of the plurality of client devices 308(1) . . . 308(n) and the TDWD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the TDWD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The TDWD 302 may be the same or similar to the TDWD 202 as described with respect to FIG. 2, including any features or combination of features described with respect thereto.

FIG. 4 illustrates a system diagram for implementing a platform, language, database, and cloud agnostic TDWM of FIG. 3 in accordance with an exemplary embodiment.

In some embodiments, the system 400 may include a platform, language, database, and cloud agnostic TDWD 402 within which a platform, language, database, and cloud agnostic TDWM 406 may be embedded, an application 403, a server 404, a generative model 407, a random number generator 409, a database(s) 412, and a communication network(s) 410. In some embodiments, the server 404 may comprise a plurality of servers located centrally or located in different locations, but the disclosure is not limited thereto.

In some embodiments, the TDWD 402 including the TDWM 406 may be connected to the application 403, the server 404, the generative model 407, the random number generator 409, and the database(s) 412 via the communication network 410. In some embodiments, the generative model 407 may not be connected to the TDWM 406. For example, the original tabular dataset (i.e., original dataset 405) output from the generative model 407 may be stored onto the database(s) 412 and the TDWM 406 may receive the original dataset 405 as input from the database(s) 412. The TDWD 402 may also be connected to the plurality of client devices 408(1)-408(n) via the communication network 410, but the disclosure is not limited thereto. The TDWM 406, the server 404, the plurality of client devices 408(1)-408(n), the database(s) 412, the communication network 410 as illustrated in FIG. 4 may be the same or similar to the TDWM 306, the server 304, the plurality of client devices 308(1)-308(n), the database(s) 312, the communication network 310, respectively, as illustrated in FIG. 3.

In some embodiments, the generative model 407 may include commonly known generative models without departing form the scope of the present disclosure, e.g., machine learning large language models, Gaussian mixture model (and other types of mixture model), hidden Markov model, probabilistic context-free grammar model, Bayesian network model (e.g. naive bayes, autoregressive model), averaged one-dependence estimators' model, Latent Dirichlet allocation model, Boltzmann machine model (e.g. Restricted Boltzmann machine, deep belief network), variational autoencoder model, generative adversarial network (GAN) model, etc., but the disclosure is not limited thereto.

In some embodiments, as illustrated in FIG. 4, the TDWM 406 may include a receiving module 414, a partitioning module 416, a dividing module 418, a computing module 420, a generating module 422, an embedding module 424, a pairing module 426, an applying module 428, a communication module 430, and a Graphical User Interface (GUI) 432. In some embodiments, interactions and data exchange among these modules included in the TDWM 406 provide the advantageous effects of the disclosed invention. Functionalities of each module of FIG. 4 may be described in detail below with reference to FIGS. 4-6.

In some embodiments, each of the receiving module 414, partitioning module 416, dividing module 418, computing module 420, generating module 422, embedding module 424, pairing module 426, applying module 428, and the communication module 430 of the TDWM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, partitioning module 416, dividing module 418, computing module 420, generating module 422, embedding module 424, pairing module 426, applying module 428, and the communication module 430 of the TDWM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 414, partitioning module 416, dividing module 418, computing module 420, generating module 422, embedding module 424, pairing module 426, applying module 428, and the communication module 430 of the TDWM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the TDWM 406 of FIG. 4 may also be implemented by cloud based deployment.

In some embodiments, each of the receiving module 414, partitioning module 416, dividing module 418, computing module 420, generating module 422, embedding module 424, pairing module 426, applying module 428, and the communication module 430 of the TDWM 406 of FIG. 4 may be called via corresponding API, but the disclosure is not limited thereto. For example, the receiving module 414 may be called via a first API, the partitioning module 416 may be called via a second API, the dividing module 418 may be called via a third API, the computing module 420 may be called via a fourth API, the generating module 422 may be called via a fifth API, the embedding module 424 may be called via a sixth API, the pairing module 426 may be called via a seventh API, the applying module 428 may be called via an eighth API, and the communication module 430 may be called via a ninth API. In some embodiments, calls may also be made using event based message interfaces in addition to APIs.

In some embodiments, the process implemented by the TDWM 406 may be executed via the communication module 430, and the communication network 410, which may comprise plural networks as described above. In some embodiments, in an exemplary embodiment, the various components of the TDWM 406 may communicate with the application 403, the server 404, the generative model 407, the random number generator 409, and the database(s) 412 via the communication module 430 and the communication network 410 and the results may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

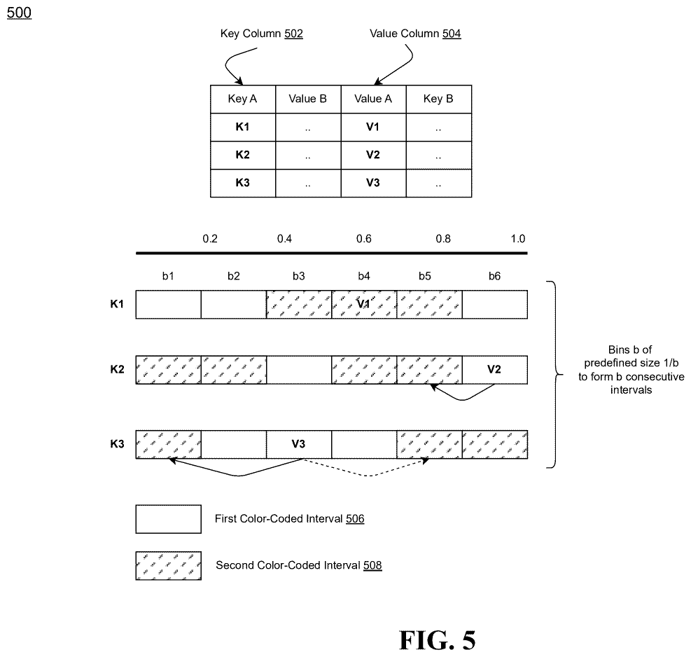

FIG. 5 illustrates an algorithm 500 for watermarking generative tabular data in a flexible and robust manner as implemented by the TDWM 406 of FIG. 4 in accordance with an embodiment.

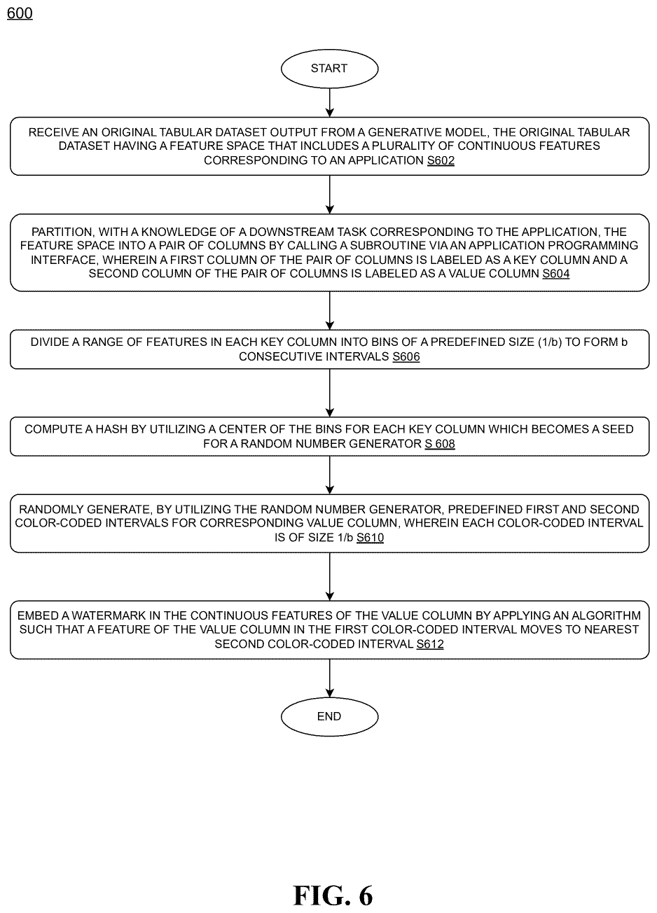

FIG. 6 illustrates a flow chart of a process 600 implemented by the TDWM 406 of FIG. 4 for watermarking generative tabular data in a flexible and robust manner in accordance with an embodiment. It may be appreciated that the illustrated process 600 and associated steps may be performed in a different order, with illustrated steps omitted, with additional steps added, or with a combination of reordered, combined, omitted, or additional steps.

Referring to FIGS. 4-6, as illustrated in FIG. 6, at step S602, the process 600 may include receiving an original tabular dataset output from a generative model. For example, at step S602, the receiving module 414 as illustrated in FIG. 4 may be called via a corresponding API to receive the original dataset 405 output from the generative model 407. The original tabular dataset 405 may include a feature space that includes a plurality of continuous features, e.g., features K1, K2, K3, V1, V2, V3, etc., as illustrated in FIG. 5, corresponding to an application 403 as illustrated in FIG. 4. As mentioned earlier, the generative model 407 may include any commonly used generative model disclosed above without departing from the scope of the present disclosure.

Continuous features (i.e., data) may describe information that may take virtually any value. This may include such as age of any applicant, salary, mortgage, deposit, or any kind of numerical measurement, without departing from the scope of the present disclosure. The type of information that produces continuous data may often be likely to change with time as well. Whereas categorical data, as opposed to continuous data, may be statistical information that may be presented according to its division into certain groups. For example, values may be sorted into predefined categories according to a design of a data analysts.

At step S604, the process 600 may include partitioning, with a knowledge of a downstream task (i.e., a client seeking to get approval for a credit card) corresponding to the application 403, the feature space into a pair of columns by calling a subroutine via an API. For example, at step S604, the partitioning module 416 as illustrated in FIG. 4 may be called by a corresponding API to partition the feature space into a pair of columns (key, value) by calling a subroutine ‘PAIR’. The partitioning module 416 may label a first column of the pair of columns as a key column 502 as illustrated in FIG. 5, and label a second column of the pair of columns as a value column 504 as illustrated in FIG. 5. For key and value, the features may be randomly assigned.

For example, if the known downstream task of the application 403 (see FIG. 4) is approving a credit card application of an applicant, deposit account information of the applicant may be assigned as a key (i.e., K1 in key column 502 Key A as illustrated in FIG. 5), salary information of the applicant may be assigned as a value (i.e., V1 in value column 504 Value A as illustrated in FIG. 5), age information of the applicant may be assigned as a value (i.e., V2 in value column 504 Value A as illustrated in FIG. 5), mortgage information, if any, of the applicant may be assigned as a key (i.e., K2 in key column 502 Key A as illustrated in FIG. 5), job information of the applicant may be assigned as a key (i.e., K3 in key column 502 Key A as illustrated in FIG. 5), rent information, if any, of the applicant may be assigned as a value (i.e., V3 in value column 504 Value A as illustrated in FIG. 5), etc., but the disclosure is not limited thereto.

For example, at step 604, in some embodiments, in partitioning the feature space into the pair of columns, the partitioning module 416 of FIG. 4 may be called via the corresponding API to pair the plurality of continuous features, i.e., K1, K2, K3, V1, V2, V3 as disclosed above with reference to FIG. 5, uniformly at random. Alternatively, in some embodiments, the partitioning module 416 of FIG. 4 may be called via the corresponding API to pair the plurality of continuous features, i.e., K1, K2, K3, V1, V2, V3 as disclosed above with reference to FIG. 5, according to a feature importance ordering, where features with similar importance are paired.

At step S606, the process 600 may include dividing a range of features in each key column into bins of a predefined size (1/b) to form b consecutive intervals. For example, at step 606, the dividing module 418 of FIG. 4 may be called via a corresponding API to divide a range of features in each key column 502 into bins b (i.e., b1, b2, b3, b4, b5, b6) of a predefined size (1/b) to form b consecutive intervals as illustrated in FIG. 5.

At step S608, the process 600 may include computing a hash by utilizing a center of the bins for each key column which becomes a seed for a random number generator. For example, at step S608, the computing module 420 may be called via a corresponding API to compute a hash by utilizing a center of the bins b for each key column 502 (see FIG. 5) which becomes a seed for a random number generator (i.e., random number generator 409 as illustrated in FIG. 4).

At step S610, the process 600 may include randomly generating, by utilizing the random number generator 409, predefined first and second color-coded intervals for corresponding value column, wherein each color-coded interval is of size 1/b. For example, at step S610, the generating module 422 may be called via a corresponding API to cause the random number generator 409 to predefined first and second color-coded intervals (see FIG. 5) for corresponding value column 504, wherein each color-coded interval is of size 1/b.

As illustrated in FIG. 5, the first color-coded interval 506 may be represented as “red interval” and the second color-coded interval 508 may be represented as “green interval” for ease of discussion throughout the instant disclosure, but the disclosure is not limited thereto. Any combination of a two color-coded intervals may be utilized other than “red” or “green” colors or other markings (e.g., white-box or dashed-box) as desired by a user without departing from the scope of the present disclosure. For example, the “red interval” may correspond to the white-box (first color-coded interval 506) and the “green interval” may correspond to the “dashed-box (second color-coded interval 508) as illustrated in FIG. 5.

Thus, as illustrated in FIG. 5, in some embodiments, for feature K1 in key column 502 Key A, bin b1 may correspond to a red interval, bin b2 may correspond to a red interval, bin b3 may correspond to a green interval, bin b4 may correspond to a green interval, bin b5 may correspond to a green interval, bin b6 may correspond to a red interval, etc., but the disclosure is not limited thereto. In some embodiments, for feature K2 in key column 502 Key A, bin b1 may correspond to a green interval, bin b2 may correspond to a green interval, bin b3 may correspond to a red interval, bin b4 may correspond to a green interval, bin b5 may correspond to a green interval, bin b6 may correspond to a red interval, etc., but the disclosure is not limited thereto. In some embodiments, for feature K3 in key column 502 Key A, bin b1 may correspond to a green interval, bin b2 may correspond to a red interval, bin b3 may correspond to a red interval, bin b4 may correspond to a red interval, bin b5 may correspond to a green interval, bin b6 may correspond to a green interval, etc., but the disclosure is not limited thereto.

At step S612 of the process 600 may include embedding the watermark in the continuous features of the value column by applying an algorithm such that a feature of the value column in the first color-coded interval moves to nearest second color-coded interval. For example, at step S612, the embedding module 424 of FIG. 4 may called via a corresponding API to embed the watermark in the continuous features, i.e., features V1, V2, V3 of the value column 504 Value A as illustrated in FIG. 5, by applying the algorithm 500 of FIG. 5 such that a feature of the value column in the first color-coded interval 506 moves to nearest second color-coded interval 508. For example, FIG. 5 illustrates a watermarking algorithm 500 on a tabular dataset with three rows (i.e., a row for features K1, V1, a row for features K2, V2, and a row for features K3, V3) and four columns (i.e., Key A, Value B, Value A, Key B). This structure corresponds to two pairs of (key, value) columns. Note that for the first row for feature K1, the feature V1 is already in a “green” interval (i.e., second color-coded interval 508 disclosed above), while the other two features V2 (for the second row for feature K2) and V3 (for the third row for feature K3) have to be moved from the “red” interval (i.e., first color-coded interval 506) to a nearby “green” interval (i.e., second color-coded interval 508 disclosed above). Thus, in this example, the embedding module 424 of FIG. 4 may be configured to move feature V2 from bin b6 (red interval) to the nearest green interval, i.e., bin b5. Similarly, the embedding module 424 of FIG. 4 may be configured to move feature V3 from bin b3 (red interval) to the nearest green interval, i.e., bin b1 or bin b5.

In some embodiments, at step S612, the embedding module 424 may be configured to embed watermark each of the generated datasets using a bin size of 10⁻² and thus may only consider columns that contain floating point numbers with at least two (2) decimal places, but the disclosure is not limited to this bin size. Any configurable bin size may be utilized in consistent with the processes disclosed herein. This choice follows from the practical consideration that watermarking with this bin size involves perturbing up to 2 decimal places and watermarking any original columns that did not already contain values with this property may make it obvious to an outside party upon receiving the dataset that this specific section of the data has been manipulated.

In some embodiments, the process 600 may repeat, by utilizing the TDWM 406 of FIG. 4), the processes of partitioning (step S604), dividing (step S606), computing (step S608), randomly generating (step S610), and embedding (step S612) as disclosed above until all value columns are watermarked, and then output a watermarked dataset 411 (see FIG. 4) of the original tabular dataset, i.e., original dataset 405 (see FIG. 4) to be utilized for the downstream task corresponding to the application 403 (see FIG. 4).

In some embodiments, in embedding the watermark in the continuous features of the value column 504 by applying the algorithm 500 as illustrated in FIG. 5, the process 600 may further include: computing a distance between empirical distributions of the original tabular dataset, i.e., original dataset 405 and the watermarked dataset 411 based on an analysis on Wasserstein distance as illustrated in FIG. 4.

It should be noted that the process 600 may move to second nearest neighbor, but it may be generalized to other nearest neighbor bins (of same color) as well as long as the process 600 may bound the Wasserstein distance appropriately.

Additional details of the watermarking algorithm disclosed above with reference to FIGS. 4-6 are provided below.

As mentioned earlier, although conventional watermarking technique may handle several attacks as well as categorical features, the result mostly focused on watermarking one feature using a random seed, which is often insufficient in practice. In contrast, the watermarking algorithm 500 as illustrated with reference to FIGS. 4-6 above may guarantee that half of the original dataset 405 are watermarked with the seed chosen based on the data in Key columns, e.g., Key A, Key B as illustrated in FIG. 5.

For example, for n∈ [symbol] , the TDMW 406 may write [n] to denote {1, . . . , n}. For a matrix X∈ [symbol] , the TDMW 406 may denote the L-infinity norm of X as ∥X∥_{∞}=max_{i∈[m],j∈[2n]} X_{i,j}. For an interval g=[a, b], TDMW 406 may denote the center of g as center (g)=(a+b)/2.

In some embodiments, the TDMW 406 may consider an original tabular dataset X∈[0,1]^{m×2n} (i.e., original dataset 414 in FIG. 4) with each column containing m i.i.d data points from a (possibly unknown) distribution Fᵢ, i∈[2n] with continuous probability density function ƒᵢ. Thus, the TDMW 406 may be configured to generate, by utilizing the generating module 422, a watermarked version of this data (i.e., watermark dataset 411 in FIG. 4) denoted X_{w}, that achieves the following properties: Fidelity: the watermarked dataset X_{w} may be close to the original data set X to maintain high fidelity, measured through L_{∞} distance and Wasserstein distance; Detectability: the watermarked dataset X_{w} may be reliably identified through the one proportion z-test using only few samples (rows); Robustness: the watermarked dataset X_{w} may achieve desirable robustness against multiple methods of attack commonly observed in data science.

In some embodiments, the TDMW 406 may be configured to embed the watermark in the continuous features of a tabular dataset by utilizing the embedding module 424 as disclosed above. While a real-world tabular dataset may contain many categorical features, embedding the watermark in these features through a small perturbation of its value may cause significant changes in the meaning for the entire sample (row). Given a dataset X with both categorical and continuous features, the TDMW 406 may run the algorithm 500 as illustrated in FIG. 5 on a smaller dataset X′⊆X with same number of rows and only continuous features. After the watermark has been embedded in X′ to get X′_{w}, the TDMW 406 may reconstruct a watermarked version of the original dataset X by replacing the continuous features of X with its watermarked versions from X′_{w}.

In some embodiments, input data for the TDMW 406 for executing the algorithm 500 for pairwise tabular watermarking disclosed above may include input data as: Tabular dataset X∈ [symbol] , Number of bins b∈ [symbol] , and Pairing subroutine PAIR. And the TDWM 406 may out a watermarked dataset X_{w} by utilizing the input data mentioned above and by implementing algorithm 500 that may include the following steps:
Divide the columns into n pairs of columns labeled (key, value) using PAIR; Bin the key columns with bin width 1/b to form consecutive intervals denoted {Iⱼ}_{j∈[b]}, where Iⱼ=[j−1/b, j/b];
for each key column do
   Use the center of the bins to compute the hash and seed a random number generator (i.e., random number generator 409 as illustrated in FIG. 4)
   Randomly generate red and green intervals (i.e., first color-coded interval 506 and second color-coded interval 508 as illustrated in FIG. 5); and denote the set of green intervals as g;

```
for each element in the paired value column do
  Identify the nearest green interval as g = arg min_{g∈G} |x − center(g)|;
  If x ∉ g then
    Replace x with x_{w} uniformly sampled from g;
  else
      Leave x as is.
```

In some embodiments, details for fidelity of pairwise tabular data watermark are described below.

First, it is shown that the output watermarked dataset X_{w} maintains high fidelity, i.e., X_{w} is close to the X in L_{∞} distance by implementing the algorithm mentioned above. Since the red and green intervals are randomly assigned, the bound on the L_{∞} distance may only hold with high probability. Intuitively, this bound may depend on the distance to the nearest green interval: the probability that a search radius contains a green interval grows with the number of adjacent bins included in the search.

Theorem 4.1 (Fidelity). Let X be a m×2n tabular dataset, and let X_{w} denote its watermarked version. With probability at least 1−δ for δ∈(0,1), the distance between X and X_{w} is upper bounded by:

$${𝔼 [ ‖ {X}_{w} - X ‖ ]}_{∞} \leq \frac{{log}_{2} ( 1 / δ )}{b} \qquad ( 1 )$$

Theorem 4.1 may give rise to a natural corollary that upper bounds the Wasserstein distance, i.e., the distance between the empirical distributions of X and X_{w}. Together, Theorem 4.1 and Corollary 4.2 (described below) may show that in expectation, the watermarked dataset X_{w} is close to the original dataset X. Thus, downstream tasks operated on X_{w} instead of X may only induce additional error in the order of 1/b with high probability. The TDWM 406 may be configured to empirically show the impact of this additional error for several synthetic and real-world datasets. For example, synthetic tabular data may include, but not limited thereto, Gaussian data generated by utilizing a dataset of size 2000×2 using the standard Gaussian distribution where one column may be designated as seed column and the other may be watermarked utilizing the algorithm 500 as disclosed herein with reference to FIG. 5. Exemplary real-world datasets of various sizes and distributions may include, but not limited to, a public dataset that is part of the University of California Irvine (UCI) Machine Learning Repository. The UCI Machine Learning Repository is a collection of databases, domain theories, and data generators that are used by the machine learning community for the empirical analysis of machine learning algorithms.

Corollary 4.2 (Wasserstein distance). Let

$${F}_{X} = {\sum }_{j = 1}^{m} {δ}_{X [ j , : ]}$$

be the empirical distribution built on X, and

$${F}_{{X}_{w}} = {\sum }_{j = 1}^{m} \frac{1}{m} {δ}_{{X}_{w} [ j , : ]}$$

be the empirical distribution built on X_{w}. Then, with probability at least 1−δ for δ∈(0,1), it can be derived by the TDWM 406 as:

$${W}_{k} ( {F}_{X} , {F}_{{X}_{w}} ) \leq \frac{\sqrt{2 n} \cdot {log}_{2} ( 1 / δ )}{b} \qquad ( 2 )$$

where Wₖ is the k-Wasserstein distance.

Details of the watermark detection protocol implemented by the TDWM 406 are provided below.

In some embodiments, the detection protocol implemented by the TDWM 406 may employ standard statistical measures to determine whether a dataset is watermarked with minimal knowledge assumptions. Particularly, the TDWM 406 may utilize the following lemma that shows, with increasing number of bins, the probability of any element in a value column belonging to a green interval approaches ½. That is, without running the watermarking algorithm, there is a baseline for the expected number of elements in green intervals for each value column.

Lemma 5.1. Consider a probability distribution F with support in [0, 1]. As the number of bins b→∞, for each element x in a value column:

$${Pr}_{x ∼ F} [ x ∈ G ] \to \frac{1}{2} \qquad ( 3 )$$

In some embodiments, the process of detecting watermark may be formalized through a hypothesis test. Intuitively, the result of Lemma 5.1 implies that, for any value column, the probability of an element being in a green list interval is approximately ½. While this convergence is agnostic to how the green intervals are chosen, it is non-trivial for a data-provider to detect the watermark due to the pairwise structure of algorithm 500 as disclosed above. Particularly, if the data-provider has knowledge of the value columns and the hash function, they still need to individually check which key column corresponds to the selected value column. In the worst case, all n key columns must be checked for each value column before the data-provider can confidently claim that the dataset is not watermarked. With this knowledge, the TDWM 406 may be configured to formulate the hypothesis test as follows: H₀: Dataset X is not watermarked; H_{0,i}: The i-th value column is not watermarked; H₀: Dataset X is watermarked.

That is, when the null hypothesis H₀ holds, then it means all of the individual null hypotheses for the i-th value column must hold simultaneously. Thus, the data-owner who wants to detect the watermark for a dataset X would need to perform the hypothesis test for each value column individually. If the goal is to reject the null hypothesis H₀ when the p-value is less than a predetermined significant threshold α (typically chosen to be 0.05 to represent 5% risk of incorrectly rejecting the null hypothesis), then the data-provider would check if the p-value for each individual null hypothesis Hoi is lower than α/n² (after accounting for error rate using Bonferroni correction-a statistical method used to reduce the likelihood of a false positive when conducting multiple hypothesis tests).

For example, let Tᵢ denote the number of elements in the i-th value column that falls into a green interval (i.e., second color-coded interval 508 as illustrated in FIG. 5). Then, under the individual null hypothesis H_{0,i}, it is derived that Tᵢ˜B(m, ½) for large number of rows m. Using Central Limit Theorem, the following equation may be derived as

$$2 \sqrt{m} ( \frac{{T}_{i}}{m} - \frac{1}{2} ) \to 𝒩 ( 0 , 1 )$$

Hence, the statistic for a one-proportion z-test is

$$z = 2 \sqrt{m} ( \frac{{T}_{i}}{m} - \frac{1}{2} )$$

For a given pair of (key, value) columns, the data-owner may calculate the corresponding z-score by counting the number of elements in value column that are in green intervals (i.e., second color-coded interval 508 as illustrated in FIG. 5). Since the TDWM 406 is performing multiple hypothesis tests simultaneously, if the dataset has 10 columns and the chosen significant level α=0.05, then the individual threshold for each column is αᵢ=0.0005. The data-owner may look up the corresponding threshold for the z-score to reject each individual null hypothesis. If the calculated z-score exceeds the threshold, then the data provider can reject the null hypothesis and claim that this value column is watermarked. On the other hand, if the z-score is below the threshold, then the data-owner cannot conclude whether this value column is watermarked or not until they have checked all possible key columns.

In some embodiments, robustness of pairwise tabular data watermark achieved by implementing the algorithm 500 by the TDWM 406 is disclosed below in details. In this section, the robustness of the watermarked dataset may be examined when they are subjected to different ‘attacks’ commonly seen in data science. It may be assumed that the attacker has no knowledge of the (key, value) pairing algorithm disclosed herein, and consequently has no knowledge of the green intervals. For example, two types of attacks may be examined: feature extraction and truncation, which are common preprocess steps before the dataset can be used for a downstream task by the application 403 (see FIG. 4).

### Robustness of Feature Selection

Given a watermarked dataset X_{w} and a downstream task, a data scientist may want to preprocess the data by dropping irrelevant features from X_{w}. Formally, it may be assumed on how to perform feature selection:

Assumption 6.1. Given a dataset X∈[0,1]^{m×2n} with features X₁, . . . , X₂ₙ, the data scientist perform feature selection according to a known feature importance order with regard to the downstream task. Then, the truncated dataset is of size m×k for k≤n, where only the top-k features with the highest importance are kept from the original dataset.

Algorithm 500 disclosed above may take a black-box pairing subroutine PAIR as an input to determine the set of (key, value) columns. In the following analysis, two feature pairing schemes may be considered: (i) uniform: features are paired uniformly at random, or (ii) feature importance: features are paired according to the feature importance ordering, where features with similar importance are paired. Without loss of generality, it may be assumed that the columns of the original dataset are ordered in descending order of feature importance. Note that this reordering of features does not affect the uniform pairing scheme and only serves to simplify notations in our analysis. Formally, given two columns Xᵢ and Xⱼ, the probability of (Xᵢ, Xⱼ) may be defined being a (key, value) pair as proportional to the inverse of the distance between their indices.

$$Pr [ ( {X}_{i} , {X}_{j} ) is pair ] = \frac{\frac{1}{\vert i - j \vert}}{{\sum }_{ℓ ∈ [ 2 n ] , ℓ \neq i \frac{1}{\vert i - j \vert}}} \qquad ( 4 )$$

In the following theorem, it may be shown that feature importance pairing may preserve more pairs of columns after the feature selection attack compared to uniform pairing.

Theorem 6.2. Given a watermarked dataset X_{w} and a data scientist attacking X with feature selection as in Assumption 6.1 disclosed above. Then, the number of preserved column pairs under feature importance pairing is at least twice as many as that under uniformly random pairing. Thus, Theorem 6.2 implies that, under the feature importance pairing scheme, the truncated dataset would retain more valuable information for the downstream task, thereby improving utility in the downstream task for various datasets as disclosed herein.

### Robustness of Truncation

In addition to feature selection, the data scientist may also “attack” the watermarked dataset (e.g., watermarked dataset 411 as illustrated in FIG. 4) by directly modifying elements in the dataset. In particular, in ‘truncation’ attack, where the data scientist reduces the number of digits after the decimal point of all elements in the dataset may be of interest. Formally, let truncate: [symbol] be the truncation function defined as:

$${x}_{tr} = truncate ( x , p ) = \frac{⌊ {10}^{P} \cdot x ⌋}{1 {0}^{P}} \qquad ( 5 )$$

That is, for all elements x∈X_{w}, the data scientist may truncate the digits in the mantissa of x to xₜᵣ∈ [symbol] with p digits in the mantissa. For example, with x=0.369 and p=2, the data scientist may truncate x to get xₜᵣ=0.36. The following analysis may be based on the case where p=2, i.e., all values are truncated to 2 decimal places. Extension to more digits in the mantissa follows the same analysis.

First, the TDWM 406 may determine how this truncation operation influence the distribution of watermarked elements in green intervals (i.e., second color-coded intervals 508 as illustrated in FIG. 5). When a watermarked element x in a value column is truncated to xₜᵣ, it may fall out of the original green interval if the bins [0, 1/b], . . . , [b−1/b, 1] and the hundredth grid points {0, 0.01, 0.02, . . . , 0.99, 1} may not be perfectly aligned. To illustrate this phenomenon, the TDWM 406 may utilize an example where algorithm 500 (see FIG. 5) uses b=150 bins for its watermarking procedure. Then, in the second bin/2=[1/150, 2/150], any element x∈[1/150, 0.01) may be truncated to xₜᵣ=0.0∈I₁. If I₁ is chosen to be a red interval (i.e., first color-coded interval 506 as illustrated in FIG. 5) by the random number generator 409 (see FIG. 4) in algorithm 500, then the truncation operation has successfully moved elements out of the green intervals. In the following theorem, the probability of successful truncation attack as a function of the bin width may be illustrated.

Theorem 6.3. Given a watermarked element xₜᵣ∈Iⱼ=[j−1/b, j/b] and the truncation function defined in Equation (5). Then, the probability that the truncated element xₜᵣ falls out of its original green interval is

$$P r [ {x}_{tr} ∉ {I}_{j} ] = \frac{{( b - 1 )}^{100} + {b}^{99} ( c \cdot b - j + 1 )}{{b}^{100}}$$

where c∈{0.00, 0.01, . . . , 1.00} is the left grid point in Iⱼ.

Thus, with larger bin size 1/b, the probability that the disclosed watermarking algorithm may withstand truncation attack increases as the truncated elements are more likely to fall into the same bins as the original elements. On the other hand, when the bins are more fine-grained, truncation would almost surely move the watermarked data outside of the original intervals. This result presents an interesting tradeoff between choosing smaller bin width for higher fidelity (see Theorem 4.1 as disclosed above) and bigger bin width for better robustness. With this insight, one may choose the bin width to be the same as the truncation grid size, i.e., 1/b=1/10^{P} or b=10^{P} to ensure high fidelity and robustness.

In some embodiments, the TDWM 406 as illustrated in FIG. 4 may utilize two common data science preprocessing steps that downstream users of the watermarked datasets might conduct: truncation and dropping the least important columns as disclosed above. For the truncation operation, the TDWM 406 may be configured to truncate to 2 decimal places as disclosed above with reference to FIG. 5. For dropping the least important columns operation, the TDWM 406 may be configured to implement an algorithm that drops the lowest 20% and 40% of columns. However, in each case the TDWM 406 may consider when the data is watermarked both with and without the feature importance based pairing algorithm disclosed above.

In some embodiments, the TDWD 402 may include a memory (e.g., a memory 106 as illustrated in FIG. 1) which may be a non-transitory computer readable medium that may be configured to store instructions for implementing a platform, language, database, and cloud agnostic TDWM 406 for watermarking generative tabular dataset as disclosed herein. The TDWD 402 may also include a medium reader (e.g., a medium reader 112 as illustrated in FIG. 1) which may be configured to read any one or more sets of instructions, e.g., software, from any of the memories described herein. The instructions, when executed by a processor embedded within the TDWM 406 or within the TDWD 402, may be used to perform one or more of the processes as described herein. In a particular embodiment, the instructions may reside completely, or at least partially, within the memory 106, the medium reader 112, and/or the processor 104 (see FIG. 1) during execution by the TDWD 402.

In some embodiments, the instructions, when executed, may cause a processor embedded within the TDWM 406 or the TDWD 402 to perform the following: receiving an original tabular dataset output from a generative model, the original tabular dataset having a feature space that includes a plurality of continuous features corresponding to an application; and partitioning, with a knowledge of a downstream task corresponding to the application, the feature space into a pair of columns by calling a subroutine via an application programming interface, wherein a first column of the pair of columns is labeled as a key column and a second column of the pair of columns is labeled as a value column; dividing a range of features in each key column into bins of a predefined size (1/b) to form b consecutive intervals; computing a hash by utilizing a center of the bins for each key column which becomes a seed for a random number generator; randomly generating, by utilizing the random number generator, predefined first and second color-coded intervals for corresponding value column, wherein each color-coded interval is of size 1/b; and embedding the watermark in the continuous features of the value column by applying an algorithm such that a feature of the value column in the first color-coded interval moves to nearest second color-coded interval. In some embodiments, the processor may be the same or similar to the processor 104 as illustrated in FIG. 1 or the processor embedded within the TDWD 202, TDWD 302, TDWD 402, and TDWM 406 which may be the same or similar to the processor 104.

In some embodiments, in partitioning the feature space into the pair of columns, the instructions, when executed, may cause the processor 104 to perform the following: pairing the plurality of continuous features uniformly at random.

In some embodiments, in partitioning the feature space into the pair of columns, the instructions, when executed, may cause the processor 104 to perform the following: pairing the plurality of continuous features according to a feature importance ordering, where features with similar importance are paired.

In some embodiments, the instructions, when executed, may cause the processor 104 to perform the following: repeating the processes of partitioning, dividing, computing, randomly generating, and embedding as disclosed above until all value columns are watermarked.

In some embodiments, the instructions, when executed, may cause the processor 104 to perform the following: outputting a watermarked dataset of the original tabular dataset to be utilized for the downstream task corresponding to the application.

In some embodiments, in embedding the watermark in the continuous features of the value column by applying the algorithm, the instructions, when executed, may cause the processor 104 to perform the following: computing a distance between empirical distributions of the original tabular dataset and the watermarked dataset based on an analysis on Wasserstein distance.

In some embodiments, the instructions, when executed, may cause the processor 104 to perform the following: embedding the watermark in the continuous features of the value column by using a bin size of 10⁻² thereby only considering columns that contain floating point numbers with at least two decimal places.

In some embodiments as disclosed above in FIGS. 1-6, technical improvements effected by the instant disclosure may include a platform for implementing a platform, language, database, and cloud agnostic tabular data watermarking module configured to implement a flexible watermarking scheme for tabular data that leverages an overall structure of a feature space to form pairs of (key, value) columns for a more fine-grained watermark embedding, thereby substantially improving data quality and downstream utility, efficiently detecting watermarked datasets, protecting underlying networks from malicious or non-malicious attacks commonly observed in data science, etc., but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for watermarking generative tabular dataset by utilizing one or more processors along with allocated memory, the method comprising:
receiving an original tabular dataset output from a generative model, the original tabular dataset having a feature space that includes a plurality of continuous features corresponding to an application; and
partitioning, with a knowledge of a downstream task corresponding to the application, the feature space into a pair of columns by calling a subroutine via an application programming interface, wherein a first column of the pair of columns is labeled as a key column and a second column of the pair of columns is labeled as a value column;
dividing a range of features in each key column into bins of a predefined size (1/b) to form b consecutive intervals;
computing a hash by utilizing a center of the bins for each key column which becomes a seed for a random number generator;
randomly generating, by utilizing the random number generator, predefined first and second color-coded intervals for corresponding value column, wherein each color-coded interval is of size 1/b; and
embedding the watermark in the continuous features of the value column by applying an algorithm such that a feature of the value column in the first color-coded interval moves to nearest second color-coded interval.

2. The method according to claim 1, wherein in partitioning the feature space into the pair of columns, the method further comprising:
pairing the plurality of continuous features uniformly at random.

3. The method according to claim 1, wherein in partitioning the feature space into the pair of columns, the method further comprising:
pairing the plurality of continuous features according to a feature importance ordering, where features with similar importance are paired.

4. The method according to claim 1, further comprising:
repeating the processes of partitioning, dividing, computing, randomly generating, and embedding until all value columns are watermarked.

5. The method according to claim 4, further comprising:
outputting a watermarked dataset of the original tabular dataset to be utilized for the downstream task corresponding to the application.

6. The method according to claim 5, wherein in embedding the watermark in the continuous features of the value column by applying the algorithm, the method further comprising:
computing a distance between empirical distributions of the original tabular dataset and the watermarked dataset based on an analysis on Wasserstein distance.

7. The method according to claim 1, further comprising:
embedding the watermark in the continuous features of the value column by using a bin size of 10⁻² thereby only considering columns that contain floating point numbers with at least two decimal places.

8. A system for watermarking generative tabular dataset, the system comprising:
a processor; and
a memory operatively connected to the processor via a communication interface, the memory storing computer readable instructions, when executed, causes the processor to:
receive an original tabular dataset output from a generative model, the original tabular dataset having a feature space that includes a plurality of continuous features corresponding to an application; and
partition, with a knowledge of a downstream task corresponding to the application, the feature space into a pair of columns by calling a subroutine via an application programming interface, wherein a first column of the pair of columns is labeled as a key column and a second column of the pair of columns is labeled as a value column;
divide a range of features in each key column into bins of a predefined size (1/b) to form b consecutive intervals;
compute a hash by utilizing a center of the bins for each key column which becomes a seed for a random number generator;
randomly generate, by utilizing the random number generator, predefined first and second color-coded intervals for corresponding value column, wherein each color-coded interval is of size 1/b; and
embed the watermark in the continuous features of the value column by applying an algorithm such that a feature of the value column in the first color-coded interval moves to nearest second color-coded interval.

9. The system according to claim 8, wherein in partitioning the feature space into the pair of columns, the processor is further configured to:
pair the plurality of continuous features uniformly at random.

10. The system according to claim 8, wherein in partitioning the feature space into the pair of columns, the processor is further configured to:
pair the plurality of continuous features according to a feature importance ordering, where features with similar importance are paired.

11. The system according to claim 8, wherein the processor is further configured to:
repeat the processes of partitioning, dividing, computing, randomly generating, and embedding until all value columns are watermarked.

12. The system according to claim 11, wherein the processor is further configured to:
output a watermarked dataset of the original tabular dataset to be utilized for the downstream task corresponding to the application.

13. The system according to claim 12, wherein in embedding the watermark in the continuous features of the value column by applying the algorithm, the processor is further configured to:
compute a distance between empirical distributions of the original tabular dataset and the watermarked dataset based on an analysis on Wasserstein distance.

14. The system according to claim 8, wherein the processor is further configured to:
embed the watermark in the continuous features of the value column by using a bin size of 10⁻² thereby only considering columns that contain floating point numbers with at least two decimal places.

15. A non-transitory computer readable medium configured to store instructions for watermarking generative tabular dataset, the instructions, when executed, cause a processor to perform the following:
receiving an original tabular dataset output from a generative model, the original tabular dataset having a feature space that includes a plurality of continuous features corresponding to an application; and
partitioning, with a knowledge of a downstream task corresponding to the application, the feature space into a pair of columns by calling a subroutine via an application programming interface, wherein a first column of the pair of columns is labeled as a key column and a second column of the pair of columns is labeled as a value column;
dividing a range of features in each key column into bins of a predefined size (1/b) to form b consecutive intervals;
computing a hash by utilizing a center of the bins for each key column which becomes a seed for a random number generator;
randomly generating, by utilizing the random number generator, predefined first and second color-coded intervals for corresponding value column, wherein each color-coded interval is of size 1/b; and
embedding the watermark in the continuous features of the value column by applying an algorithm such that a feature of the value column in the first color-coded interval moves to nearest second color-coded interval.

16. The non-transitory computer readable medium according to claim 15, wherein in partitioning the feature space into the pair of columns, the instructions, when executed, cause the processor to perform the following:
pairing the plurality of continuous features uniformly at random.

17. The non-transitory computer readable medium according to claim 15, wherein in partitioning the feature space into the pair of columns, the instructions, when executed, cause the processor to perform the following:
pairing the plurality of continuous features according to a feature importance ordering, where features with similar importance are paired.

18. The non-transitory computer readable medium according to claim 15, wherein the instructions, when executed, cause the processor to perform the following:
repeating the processes of partitioning, dividing, computing, randomly generating, and embedding until all value columns are watermarked; and
outputting a watermarked dataset of the original tabular dataset to be utilized for the downstream task corresponding to the application.

19. The non-transitory computer readable medium according to claim 18, wherein in embedding the watermark in the continuous features of the value column by applying the algorithm, the instructions, when executed, cause the processor to perform the following:
computing a distance between empirical distributions of the original tabular dataset and the watermarked dataset based on an analysis on Wasserstein distance.

20. The non-transitory computer readable medium according to claim 15, wherein the instructions, when executed, cause the processor to perform the following:
embedding the watermark in the continuous features of the value column by using a bin size of 10⁻² thereby only considering columns that contain floating point numbers with at least two decimal places.
